(19) United States
(12) Patent Application Publication
(10) Pub. No.: US 2025/0291274 A1
(43) Pub. Date: Sep. 18, 2025

(54) IMAGE-FORMING DEVICE INCLUDING CONSUMABLE INCLUDING CONSUMABLE MEMORY HAVING FIRST AREA SUBJECT TO DIGITAL SIGNATURE AND SECOND AREA NOT SUBJECT TO DIGITAL SIGNATURE

(71) Applicant: BROTHER KOGYO KABUSHIKI KAISHA, Nagoya (JP)

(72) Inventor: Rintaro MORI, Kasugai (JP)

(73) Assignee: BROTHER KOGYO KABUSHIKI KAISHA, Nagoya (JP)

(21) Appl. No.: 19/222,028

(22) Filed: May 29, 2025

Related U.S. Application Data
(63) Continuation of application No. PCT/JP2023/038866, filed on Oct. 27, 2023.

(30) Foreign Application Priority Data
Nov. 30, 2022 (JP) 2022-191339

(51) Int. Cl. G03G 15/08; G03G 15/00

(52) U.S. Cl. CPC G03G 15/0863; G03G 15/5016

(57) ABSTRACT

An image-forming device includes a device main body, a consumable, and a controller. The consumable is attachable to the device main body, and includes a consumable memory having a first area subject to a digital signature and a second area not subject to a digital signature. The controller is configured to perform a configuration process. The configuration process includes configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The configuration process includes configuring, when the switching information is stored in the second area of the consumable memory, the operational setting using the reference information based on the switching information.

### REFERENCE TO RELATED APPLICATIONS

This is a by-pass continuation application of International Application No. PCT/JP2023/038866 filed on Oct. 27, 2023 which claims priority from Japanese Patent Application No. 2022-191339 filed on Nov. 30, 2022. The entire contents of the International Application and the priority application are incorporated herein by reference.

### BACKGROUND ART

A known printer determines the operating mode of the printer based on information stored in a print cartridge, which is a consumable. The memory of the print cartridge includes an area requiring a digital signature, and the area stores setting data for determining the operating mode of the printer.

### SUMMARY

For example, in a known image-forming device to which a recycled consumable is to be attached, there is a demand for the operational settings of the device to be configured based on the consumable after recycling.

However, in the known printer, since the setting data is stored in the memory area requiring a digital signature, when the setting data is changed, the changed setting data requires a digital signature. Therefore, it is inconvenient to configure the operational settings of the device based on the consumable, and there remains room for improvement.

In view of the foregoing, it is an object of the present disclosure to easily configure the operation settings of the image-forming device based on the consumable.

In order to attain the above and other objects, according to one aspect, the present disclosure provides an image-forming device including a device main body, a consumable, a controller. The consumable is attachable to the device main body. The consumable includes a consumable memory. The consumable memory has a first area subject to a digital signature, and a second area not subject to a digital signature. The controller is configured to perform a configuration process. The configuration process includes configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The configuration process further includes configuring, when the switching information is stored in the second area of the consumable memory, the operational setting using the reference information based on the switching information.

According to another aspect, the present disclosure provides a control method of controlling an image-forming device. The image-forming device includes a device main body, a controller, and a consumable. The consumable is attachable to the device main body. The consumable includes a consumable memory. The consumable memory has a first area subject to a digital signature, and a second area not subject to a digital signature. The control method includes the controller configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The control method further includes the controller configuring, when the switching information is stored in the second area of the consumable memory, the operational setting using the reference information based on the switching information.

According to still another aspect, the present disclosure provides a consumable attachable to an image-forming device including a controller. The consumable includes a consumable memory. The consumable memory] has a first area subject to a digital signature, and a second area not subject to a digital signature. The controller is configured to perform a configuration process. The configuration process includes configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The configuration process further includes configuring, when the switching information is stored in the second area of the consumable memory, the operational setting using the reference information based on the switching information.

With the above configurations, since the basic information, which is the main information, is stored in the area subject to a digital signature (i.e., the first area), information tampering can be detected based on the digital signature. Furthermore, the switching information can be stored in the area not subject to a digital signature (i.e., the second area) in the consumable memory. Therefore, in the configuration process, when the switching information is stored in the area not subject to a digital signature (i.e., the second area) in the consumable memory, the operational setting of the image-forming device can be configured using the reference information based on the switching information. Accordingly, the operational setting based on the consumable can be easily configured while restricting tampering of the basic information.

### BRIEF DESCRIPTION OF DRAWINGS

FIG. 1 is a schematic diagram illustrating an image-forming device.

FIG. 2 is a diagram illustrating the main components of the image-forming device, including drum cartridges and toner cartridges.

FIG. 3 is a diagram illustrating an example of the data structure of a toner cartridge information stored in a toner memory.

FIG. 4 is a diagram illustrating an example of a memory map of the toner memory.

FIG. 5 is a flowchart illustrating an example of steps in an operational setting process executed by the image-forming device.

FIG. 6 is a flowchart illustrating an example of steps in a first operational setting process illustrated in FIG. 5.

FIG. 7 is a flowchart illustrating an example of steps in a second operational setting process illustrated in FIG. 5.

FIG. 8 is a flowchart illustrating another example of steps in another first operational setting process.

### DESCRIPTION

### First Embodiment

Hereinafter, a first embodiment of the present disclosure will be described while referring to the accompanying drawings. In the present embodiment, an image-forming device 1 will be described, for example, as a laser printer configured to form images on printing media using toner. However, the image-forming device 1 of the present disclosure may be a printer other than a laser printer. For example, the image-forming device 1 may be an inkjet printer.

### Overall Configuration of Image-Forming Device 1

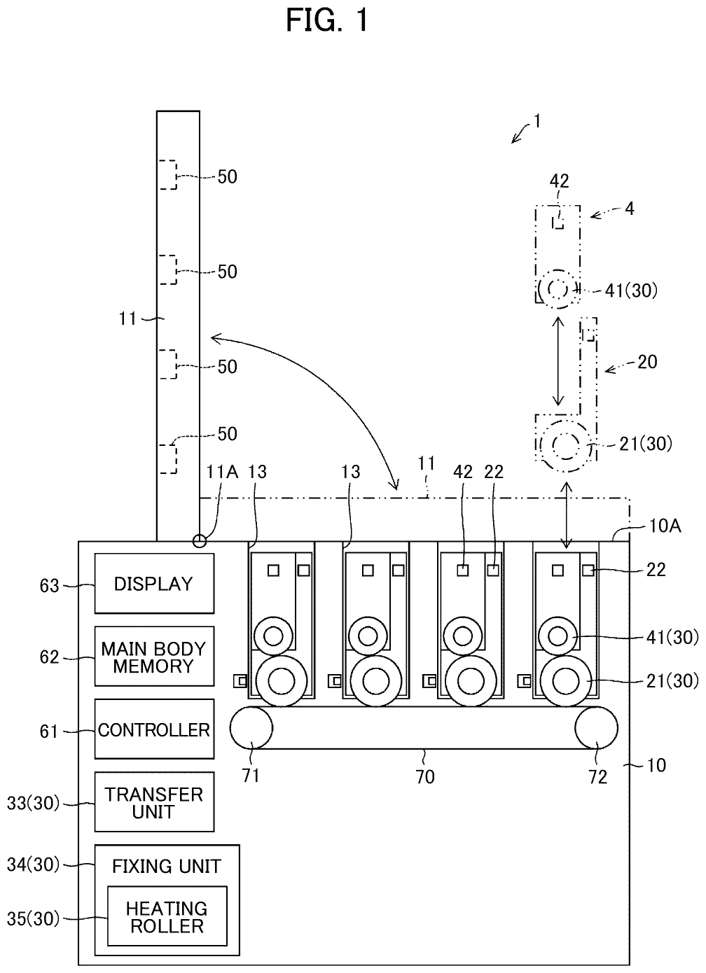

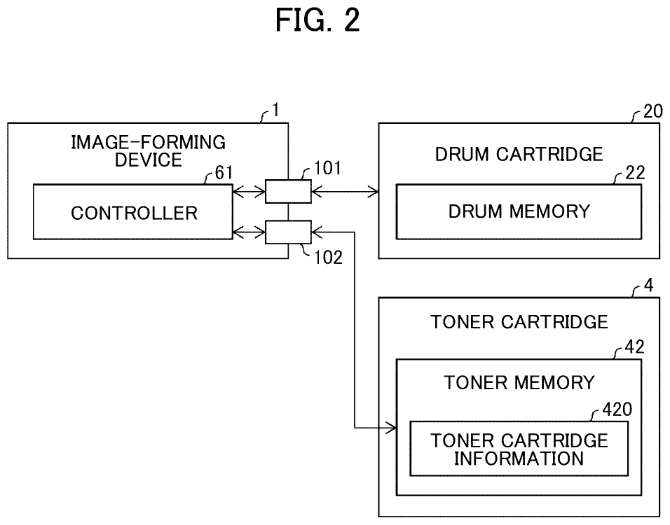

FIG. 1 is a schematic diagram of the image-forming device 1. FIG. 2 is a diagram illustrating the internal structure of the image-forming device 1, which includes toner cartridges 4.

As illustrated in FIG. 1, the image-forming device 1 includes a main body housing 10, and a cover 11. The image-forming device 1 further includes the toner cartridges 4, drum cartridges 20, a transfer belt 70, a controller 61, a main body memory 62, and a display 63. The image-forming device 1 may further include an image-forming unit 30.

### Main Body Housing 10

The main body housing 10 is an example of the device main body according to the present disclosure. The main body housing 10 has a rectangular box shape, for example. The main body housing 10 accommodates the toner cartridges 4, the drum cartridges 20, the image-forming unit 30, the controller 61, the main body memory 62, the display 63, and the transfer belt 70.

The display 63 may be disposed at the main body housing 10. Additionally, the display surface of the display 63 may be disposed on the outer surface of the main body housing 10 so that the user can visually recognize displayed information. The display 63 may also be integrally configured with a touchscreen so as to function as an operation unit.

The toner cartridges 4 are attachable to the main body housing 10 of the image-forming device 1. As will be described later in detail, each of the toner cartridges 4 becomes integrated with the corresponding drum cartridge 20 by being attached to the drum cartridge 20. In other words, the toner cartridge 4 is to be attached to the main body housing 10 together with the drum cartridge 20 in a state where the toner cartridge 4 is attached to the drum cartridge 20.

Note that, in the present embodiment, four toner cartridges 4 are to be attached to the image-forming device 1. In other words, in the present embodiment, four toner cartridges 4 and four drum cartridges 20 are attachable to the image-forming device 1. However, the numbers of drum cartridges 20 and toner cartridges 4 to be attached to the image-forming device 1 are not limited to the example illustrated in FIG. 1. For example, the image-forming device 1 may be a monochrome printer to which a single drum cartridge 20 and a single toner cartridge 4 are attachable.

The main body housing 10 has four cartridge holders 13. Each of the cartridge holders 13 has a recessed shape and has an opening. The toner cartridges 4 and drum cartridges 20 are attached to the main body housing 10 by being held in the corresponding cartridge holders 13.

### Cover 11

A respective light source unit 50 is disposed on the cover 11 of the image-forming device 1 for each of the drum cartridges 20. That is, the image-forming device 1 includes four light source units 50. The cover 11 is pivotable (movable) about a pivot shaft 11A between an open position (a position indicated by solid lines in FIG. 1) in which the cover 11 opens an opening 10A and a closed position (a position indicated by two-dotted chain lines in FIG. 1) in which the cover 11 closes the opening 10A. The opening 10A, which is defined in the upper end of the main body housing 10, is opened and closed by pivoting of the cover 11.

The openings of the cartridge holders 13 are opened when the cover 11 is placed in the open position. The openings of the cartridge holders 13 are covered by the cover 11 when the cover 11 is placed in the closed position.

A closure sensor not illustrated in the drawings may be disposed at the opening 10A of the main body housing 10. The closure sensor is a sensor configured to detect that the cover 11 is in the closed position. The closure sensor may be a contact-type sensor or an optical sensor, for example.

### Toner Cartridges 4

Each of the toner cartridges 4 accommodates toner. The image-forming device 1 consumes toner accommodated in each of the toner cartridges 4 to perform printing. The toner cartridges 4 are each an example of the consumable for use with the image-forming device 1.

Each of the toner cartridges 4 includes a developing roller 41, and a cartridge housing that can accommodate developer, which is an example of the printing material. The following description assumes that the developer to be used is toner, which is an example of the developer. Each of the cartridge housings of the toner cartridges 4 is attachable to the main body housing 10. The four toner cartridges 4 accommodate toner in colors different from one another (for example, colors of cyan, magenta, yellow, and black) as the material to be used for image formation. Toner is a material that is consumed through use. When the toner cartridge 4 is attached to the corresponding drum cartridge 20, the outer circumferential surface of a photosensitive drum 21 contacts the outer circumferential surface of the developing roller 41. The developing roller 41 supplies toner onto the photosensitive drum 21.

Each of the toner cartridges 4 also includes a toner memory 42, as illustrated in FIG. 2. The toner memory 42 is an example of the consumable memory. The toner memory 42 is disposed on the outer surface of one side portion of the toner cartridge 4 in a first direction. The toner memory 42 is a memory to which information is writable and from which information is readable. For example, the toner memory 42 is a flash Read-Only Memory (ROM) or an Electrically Erasable and Programmable Read-Only Memory (EEPROM). “EEPROM” is a registered Japanese trademark of Renesas Electronics Corporation.

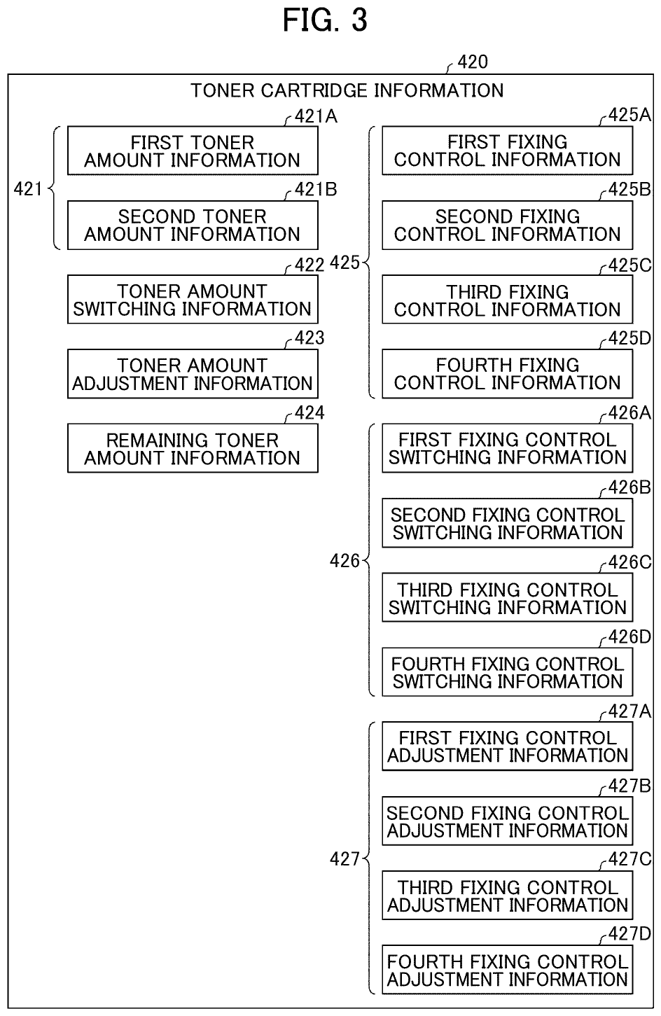

Each of the toner memories 42 can store toner cartridge information 420, which is information related to the corresponding toner cartridge 4. The toner cartridge information 420 stores information related to settings for the operation of the image-forming device 1 based on the toner cartridge 4. Hereinafter, settings for the operation of the image-forming device 1 will be referred to simply as the “operational settings”. The data structure of the toner cartridge information 420 will be described with reference to FIG. 3.

### Drum Cartridges 20

Each of the drum cartridges 20 includes a cartridge housing to which the corresponding toner cartridge 4 is to be attached, as illustrated in FIG. 1. Each of the drum cartridges 20 includes the photosensitive drum 21 as a component to be used during an image formation process. The outer circumferential surface of the photosensitive drum 21 is coated with a photosensitive material. The photosensitive drum 21 is a replacement component which needs to be replaced since the photosensitive drum 21 is deteriorated through use, such as wear of the outer circumferential surface of the photosensitive drum 21. The drum cartridges 20 are each also an example of the consumable for use with the image-forming device 1.

As illustrated in FIG. 2, each of the drum cartridges 20 may include a drum memory 22, which is an example of the consumable memory. The drum memory 22 is a memory to which information is writable and from which information is readable. The drum memory 22 is a flash ROM or an EEPROM, for example. Each of the drum memories 22 can store drum cartridge information related to the corresponding drum cartridge 20. As with the toner cartridge information 420 stored in each of the toner memories 42, the drum cartridge information may store information related to the operational settings based on the corresponding drum cartridge 20.

### Attachment of Cartridges and Printing Mechanism

As illustrated in FIG. 1, the toner cartridges 4 and the drum cartridges 20 are to be attached to the main body housing 10 in a state where the cover 11 is placed in the open position. In this state, the toner cartridges 4 and the drum cartridges 20 are to be inserted into the corresponding cartridge holders 13 through the opening 10A.

The four light source units 50 are installed on the inner surface of the cover 11. In a state where the drum cartridges 20 are attached to the main body housing 10 and the cover 11 is in the closed position, the light source units 50 are positioned so as to face the outer circumferential surfaces of the corresponding photosensitive drums 21. Each of the light source units 50 includes a plurality of light sources arrayed in the first direction. The light sources can irradiate the outer circumferential surface of the corresponding photosensitive drum 21 with light. The light sources are Light-Emitting Diodes (LEDs), for example.

Each of the light source units 50 is electrically connected to the controller 61. The controller 61 controls the light source units 50 according to inputted image data to emit light from the light sources in the light source units 50. The light sources of each of the light source units 50 emit light toward the outer circumferential surface of the corresponding photosensitive drum 21. As a result, the photosensitive material on the outer circumferential surfaces of the photosensitive drums 21 is exposed to light according to the image data.

The transfer belt 70 is a component for transferring developer (e.g., toner) carried on the surfaces of the photosensitive drums 21 onto a printing medium. The transfer belt 70 is a replacement component which needs to be replaced since the transfer belt 70 is deteriorated through use, such as wear of the surface of the transfer belt 70. The transfer belt 70 is a belt having a looped shape (an endless belt) that can contact the photosensitive drums 21. The outer circumferential surfaces of the photosensitive drums 21 can contact the outer peripheral surface of the transfer belt 70. During an image forming process, the printing medium is conveyed to a position between the transfer belt 70 and the photosensitive drums 21.

The transfer belt 70 is looped over a drive roller 71 and a follow roller 72. The drive roller 71 drives the transfer belt 70. The controller 61 controls the drive roller 71 to rotate. The follow roller 72 rotates in response to movement of the transfer belt 70 by driving of the drive roller 71.

The image-forming unit 30 forms an image on the printing medium by performing an image forming process. The image-forming unit 30 includes the photosensitive drums 21, the developing rollers 41, a transfer unit 33, and a fixing unit 34. The transfer unit 33 is configured to transfer toner supplied onto the photosensitive drum 21 onto the printing medium. The transfer unit 33 includes the transfer belt 70, the drive roller 71, and the follow roller 72. The fixing unit 34 is configured to fix the toner transferred onto the printing medium to the printing medium by heating the printing medium using a heating roller 35. Additionally, the image-forming unit 30 may further include an exposure unit for exposing the photosensitive drums 21 to light by emitting predetermined light beams to the photosensitive drums 21, and a charger for uniformly charging the surfaces of the photosensitive drums 21. The fixing unit 34 is an example of the fixing device.

### Internal Structure of Device Main Body

The controller 61 includes an Application-Specific Integrated Circuit (ASIC), for example. The controller 61 is electrically connected to the main body memory 62 disposed in the main body housing 10 of the image-forming device 1. Although not illustrated in the drawings, the display 63 is also electrically connected to the controller 61. The controller 61 executes various operations to cause the image-forming device 1 to perform various processes related to printing.

The controller 61 may include a processor, such as a Central Processing Unit (CPU). In this case, a control program for implementing a control method of controlling the image-forming device 1 may be stored in the main body memory 62. The processor of the controller 61 may operate according to the control program to cause the image-forming device 1 to perform various processes. The term “processor” encompasses both a single processor or a group of multiple processors located either locally or remotely working together or in a distributed fashion to collectively perform the tasks attributed to the “processor” described herein.

The controller 61 may include a computer-readable storage medium such as the main body memory 62 that stores the control program. The storage medium may be a “non-transitory, tangible medium,” such as a ROM, a tape, a disc, a card, a semiconductor memory, or a programmable logic circuit. A Random-Access Memory (RAM) may also be used for developing the control program, for example. The control program may also be supplied to the above computer via any transmission medium (a communication network, broadcast waves, etc.) that can transmit the control program. Note that, one aspect of the present disclosure can be implemented in the form of data signals embedded in a carrier wave, which embodies the control program through electronic transmission.

As illustrated in FIG. 2, the image-forming device 1 includes connectors 101, and connectors 102. In a state where the drum cartridge 20 is inserted into the corresponding cartridge holder 13, as illustrated in FIG. 1, the corresponding connector 101 is electrically connected to the drum memory 22 of the drum cartridge 20, thereby enabling the controller 61 to communicate with the drum memory 22 of the drum cartridge 20. Consequently, the controller 61 can execute a read process to read information from the drum memory 22 and a write process (including a rewrite process) to write information to the drum memory 22.

Additionally, in a state where the toner cartridge 4 is attached to the main body housing 10, the corresponding connector 102 is electrically connected to the toner memory 42 of the toner cartridge 4, thereby enabling the controller 61 to communicate with the toner memory 42 of the toner cartridge 4. Consequently, the controller 61 can execute a read process to read information from the toner memory 42 and a write process (including a rewrite process) to write information to the toner memory 42.

The main body memory 62 is a memory to which information is writable and from which information is readable. The main body memory 62 is a flash ROM, or an EEPROM, for example. The main body memory 62 has one or more storage areas, which store various information as described below, for example.

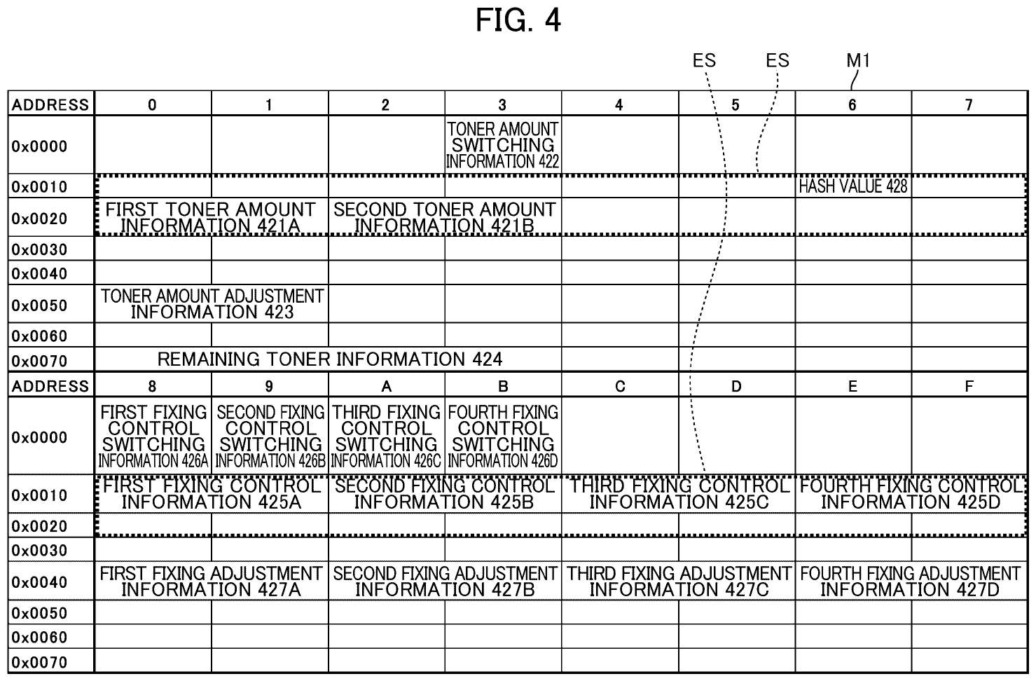

The main body memory 62 stores cartridge information related to the cartridges to be attached to the image-forming device 1. Specifically, the cartridge information includes the toner cartridge information 420 read from each of the toner memories 42 of the toner cartridges 4 corresponding to the respective colors so that each of the toner cartridges 4 corresponding to the respective colors can be identified. Additionally, the cartridge information also includes drum cartridge information read from each of the drum memories 22 of the drum cartridges 20 so that each of the drum cartridges 20 can be individually identified. The drum cartridge information 220 includes usage amount information indicating the usage amount of the corresponding drum cartridge 20, for example. The data structure of the toner cartridge information 420 stored as the cartridge information will be described in detail with reference to FIGS. 3 and 4.

### Data Structure of Cartridge Information

### Toner Cartridge Information 420

FIG. 3 is a diagram illustrating an example of the data structure of the toner cartridge information 420 stored in the toner memory 42. The toner cartridge information 420 includes toner amount information 421, toner amount switching information 422, toner amount adjustment information 423, remaining toner information 424, fixing control information 425, fixing control switching information 426, and fixing control adjustment information 427, for example. Although not illustrated in the drawings, the toner cartridge information 420 may include other information related to the toner cartridge 4, such as usage amount information indicating the usage amount of the toner cartridge 4.

The toner amount information 421 includes first toner amount information 421A, and second toner amount information 421B. The toner amount information 421 is an example of the basic information related to the operational settings. The toner amount information 421 is to be used as the basic information to configure the operational settings. In the present embodiment, the first toner amount information 421A is information indicating the initial toner fill amount of the toner cartridge 4. The initial toner fill amount of the toner cartridge 4 denotes the amount of toner stored in the toner cartridge 4 at the time of shipment of the toner cartridge 4 from a factory. The second toner amount information 421B is information indicating the maximum amount of toner that can be stored in the toner cartridge 4.

The toner amount switching information 422 is information for switching reference information to be used for configuring the operational settings. The toner amount switching information 422 is an example of the switching information. The toner amount switching information 422 is information indicating that at least one of the toner amount information 421 or the toner amount adjustment information 423 (described later) is to be used as the reference information in a configuration process (described later). When the toner amount switching information 422 is stored in the toner memory 42, the operational settings are configured using the reference information based on the toner amount switching information 422.

The toner amount adjustment information 423 is information indicating an adjustment value for configuring the operational settings based on the toner cartridge 4. The toner amount adjustment information 423 is an example of the adjustment information. In the present embodiment, the toner amount adjustment information 423 is an adjustment value for identifying the post-recycling toner amount of the toner cartridge 4. The post-recycling toner amount of the toner cartridge 4 denotes the amount of toner stored in the toner cartridge 4 at the time of completion of the most recent recycling of the toner cartridge 4 that includes toner refilling.

In the present embodiment, the toner amount adjustment information 423 may be, for example, an adjustment value indicating the post-recycling toner amount of the toner cartridge 4. For example, in a case where the post-recycling toner amount of the toner cartridge 4 is 100 g, the toner amount adjustment information 423 is a value indicating 100 g. In this case, instead of the first toner amount information 421A, the toner amount adjustment information 423 is to be used for configuring the operational settings. Additionally, the toner amount adjustment information 423 may be an adjustment value indicating the difference between the post-recycling toner amount of the toner cartridge 4 and the first toner amount information 421A. For example, when the post-recycling toner amount of the toner cartridge 4 is 80 g, and the first toner amount information 421A is 100 g, the toner amount adjustment information 423 is a value indicating −20 g. Note that the toner amount adjustment information 423 may be information indicating the amount of toner with which the toner cartridge 4 has been refilled during the most recent recycling.

The remaining toner amount information 424 is information indicating the amount of toner remaining in the toner cartridge 4. The remaining toner amount information 424 is information indicating the remaining toner amount calculated based on the amount of toner consumed during printing, and is updated each time printing is performed. The remaining toner amount information 424 may be calculated based on the amount of toner stored in the toner cartridge 4 calculated using at least one of the toner amount information 421, the toner amount switching information 422, or the toner amount adjustment information 423.

The fixing control information 425 is information related to settings for the operation of the image-forming unit 30 based on the toner cartridge 4. More specifically, the fixing control information 425 is information related to operational settings for the fixing unit 34 of the image-forming unit 30. The fixing control information 425 is an example of the basic information. The operational settings are configured using the fixing control information 425 as the basic information. The fixing control information 425 is, for example, information for configuring the operational settings based on the composition of toner stored in the toner cartridge 4 and the characteristics of a printing medium (i.e., the size or type of the printing medium) used for printing.

The fixing control information 425 includes first through fourth fixing control information 425A-425D. In the present embodiment, the first through fourth fixing control information 425A-425D are the default target temperatures for the heating roller 35 of the fixing unit 34 during printing. The default target temperatures denote the target temperatures based on the toner stored in the toner cartridge 4 at the time of shipment of the toner cartridge 4 from a factory. For example, the first fixing control information 425A is the default target temperature to be set when a first printing medium is conveyed at a first speed. The first speed is the maximum speed for conveying printing media. Additionally, the second fixing control information 425B is the default target temperature to be set when the first printing medium is conveyed at a second speed. The second speed is half the speed of the first speed. In addition, the third fixing control information 425C is the default target temperature to be set when a second printing medium different from the first printing medium is conveyed at the first speed. Furthermore, the fourth fixing control information 425D is the default target temperature to be set when the second printing medium is conveyed at the second speed.

The fixing control switching information 426 is information for switching reference information to be used for configuring the operational settings. More specifically, the fixing control switching information 426 is information for switching the operational settings of the fixing unit 34 of the image-forming unit 30. The fixing control switching information 426 is an example of the switching information. The fixing control switching information 426 is information indicating that at least one of the fixing control information 425 or the fixing control adjustment information 427 (described later) is to be used as the reference information in the configuration process (described later). When the fixing control switching information 426 is stored in the toner memory 42, the operational settings are configured using the reference information based on the fixing control switching information 426. The fixing control switching information 426 includes first through fourth fixing control switching information 426A-426D. The first through fourth fixing control switching information 426A-426D correspond to the first through fourth fixing control information 425A-425D, respectively.

The fixing control adjustment information 427 is information indicating adjustment values for configuring the operational settings based on the toner cartridge 4. More specifically, the fixing control adjustment information 427 is information indicating adjustment values related to the operational settings of the fixing unit 34 of the image-forming unit 30. The fixing control adjustment information 427 is an example of the adjustment information. The fixing control adjustment information 427 includes first through fourth fixing control adjustment information 427A-427D. The first through fourth fixing control adjustment information 427A-427D correspond to the first through fourth fixing control information 425A-425D, respectively.

In the present embodiment, the fixing control adjustment information 427 is the adjustment values indicating the post-recycling target temperatures for the heating roller 35 of the fixing unit 34 during printing. The post-recycling target temperatures denote the target temperatures based on the toner stored in the toner cartridge 4 at the time of completion of the most recent recycling of the toner cartridge 4 that includes toner refilling. In this case, instead of the fixing control information 425, the fixing control adjustment information 427 is to be used for configuring the operational settings. Note that the fixing control adjustment information 427 may be adjustment values indicating the differences between the fixing control information 425 and the post-recycling target temperatures of the heating roller 35.

The controller 61 of the image-forming device I uses at least one of the fixing control information 425, the fixing control switching information 426, or the fixing control adjustment information 427 to configure the operational settings. When the operational settings are configured, during printing the controller 61 controls the actual temperature of the heating roller 35 such that the actual temperature matches the target temperature based on the toner cartridge 4.

### Example of Memory Map of Toner Memory 42

FIG. 4 is a diagram illustrating an example of a memory map of the toner memory 42. A map M1 as an example of the memory map of the toner memory 42 is illustrated in FIG. 4. However, the memory map of the toner memory 42 is not limited to the example illustrated in FIG. 4.

In FIG. 4, addresses 0x0000 to 0x007F of the map M1 of the toner memory 42 are illustrated. The memory capacity of the smallest addressable unit in the map M1 is one byte, for example. Each piece of information included in the toner cartridge information 420 is stored in the toner memory 42 to correspond to one or more addresses of the map M1. For example, the first toner amount information 421A is stored in the region from addresses 0x0020 to 0x0021 of the map M1, and has a memory capacity of two bytes.

Addresses 0x0010 to 0x002F of the map M1 are an area ES subject to a digital signature. Therefore, a digital signature is required to store information in the area ES of the map M1. In the area ES, a digital signature is added to information to be stored. The addresses of the map M1 other than 0x0010 to 0x002F are an area not subject to a digital signature. Therefore, in the area of the map M1 other than the area ES, a digital signature is not required, and no digital signature is added to information to be stored. Note that the verification of a digital signature for information to be stored in the area ES is performed using well-known technologies related to digital signatures. For example, in digital signatures, a method is employed in which a hash value calculated using a hash function is compared with a pre-calculated hash value. Note that a pre-calculated hash value 428 is stored in the area ES. The area ES is an example of the first area. The area of the map M1 other than the area ES is an example of the second area.

The first toner amount information 421A, the second toner amount information 421B, the first fixing control information 425A, the second fixing control information 425B, the third fixing control information 425C, and the fourth fixing control information 425D are stored in the area ES of the map M1. In other words, to restrict rewriting, the area ES of the map M1 stores the basic information serving as a basis for the operational settings. Accordingly, when information stored in the area ES of the map M1 is rewritten, information tampering can be detected. Note that the area ES of the map M1 may store information other than the information illustrated in FIG. 4.

All the pieces of information included in the toner cartridge information 420 illustrated in FIG. 3, excluding the first to second toner amount information 421A-421B and the first to fourth fixing control information 425A-425D, are to be stored in the area of the map M1 other than the area ES. For example, the toner amount switching information 422, the toner amount adjustment information 423, the fixing control switching information 426, and the fixing control adjustment information 427 are to be stored in the area other than the area ES. Information stored in the area other than the area ES can be rewritten without a digital signature. Therefore, the operational settings based on the toner cartridge 4 can be easily configured.

### Operational Setting Process

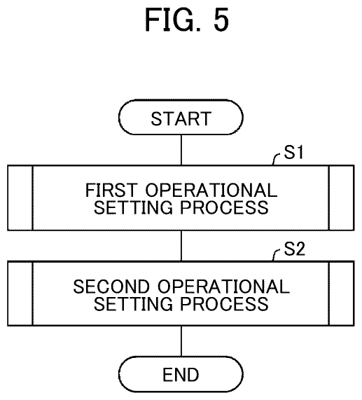

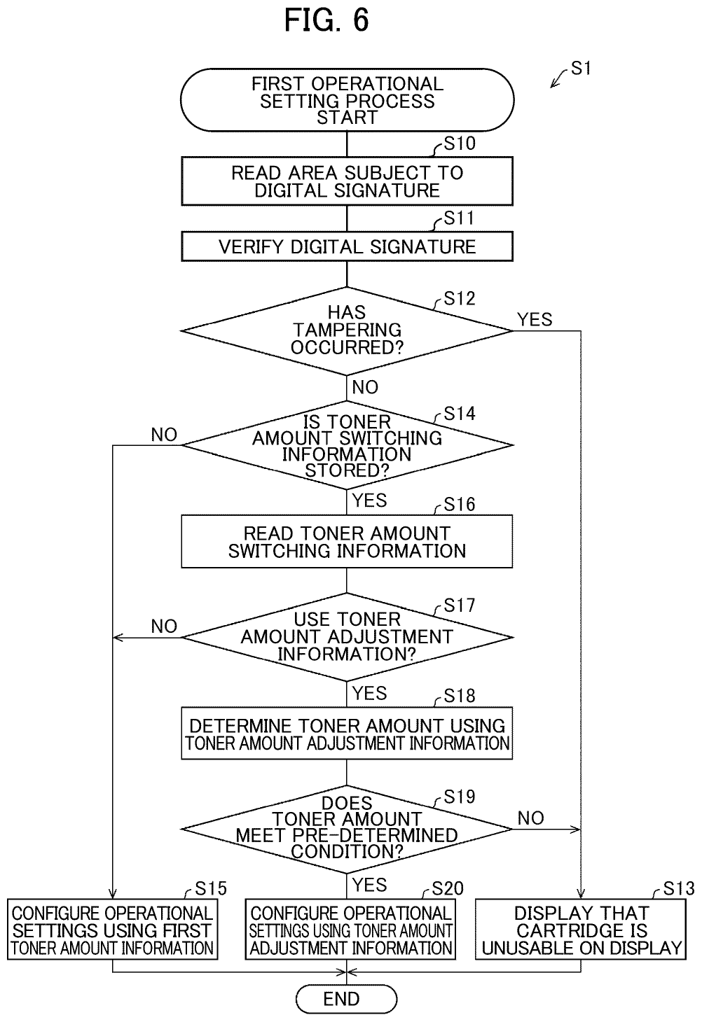

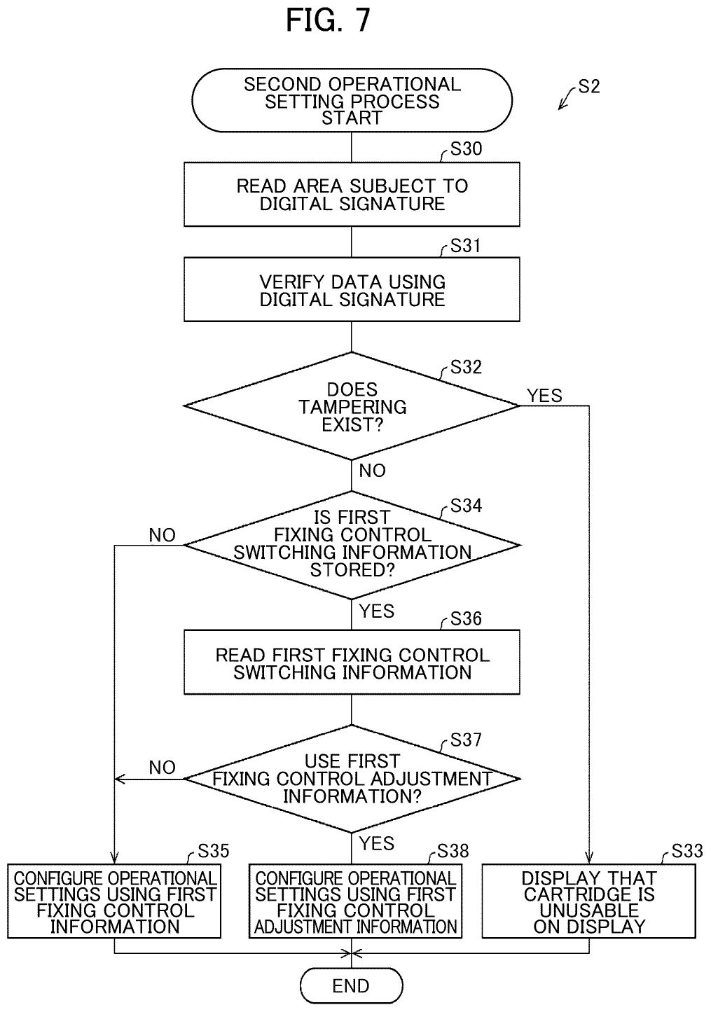

An operational setting process executed by the image-forming device 1 will be described with reference to FIGS. 5 through 7. FIG. 5 is a flowchart illustrating an example of steps in the operational setting process executed by the image-forming device 1. FIG. 6 is a flowchart illustrating an example of steps in a first operational setting process illustrated in FIG. 5. FIG. 7 is a flowchart illustrating an example of steps in a second operational setting process illustrated in FIG. 5.

As illustrated in FIG. 5, when the toner cartridge 4 is attached to the main body housing 10, the controller 61 of the image-forming device 1 performs the operational setting process based on the attached toner cartridge 4. First, the controller 61 executes the first operational setting process (S1). The first operational setting process is an operational setting process performed based on toner amount-related information stored in the toner memory 42.

The first operational setting process will be described with reference to FIG. 6. First, the controller 61 reads the area ES of the toner memory 42, which is subject to a digital signature (S10). In other words, in step S10, the controller 61 reads the toner amount information 421 stored in the area ES. More specifically, in step S10, the controller 61 reads the first toner amount information 421A. Additionally, the controller 61 may read the second toner amount information 421B in step S10.

Next, the controller 61 verifies the digital signature added to the toner amount information 421 (S11). Next, the controller 61 determines, based on the verification result of step S11, whether information tampering has occurred (S12). When information tampering has occurred (S12: YES), the controller 61 executes a process to display on the display 63 that the toner cartridge 4 is unusable (S13). Step S13 is an example of the displaying process. After step S13, the controller 61 ends the first operational setting process. On the other hand, when information tampering has not occurred (S12: NO), the controller 61 determines whether the toner amount switching information 422 is stored in the toner memory 42 (S14).

When the toner amount switching information 422 is not stored (S14: NO), the controller 61 configures the operational settings using the first toner amount information 421A (S15). In other words, in step S15, the controller 61 configures the operational settings using the toner amount indicated by the first toner amount information 421A. After step S15, the controller 61 ends the first operational setting process. On the other hand, when the toner amount switching information 422 is stored (S14: YES), the controller 61 reads the toner amount switching information 422 (S16).

Next, the controller 61 determines whether the toner amount switching information 422 read in step S16 includes information indicating that the toner amount adjustment information 423 is to be used (S17). When the toner amount adjustment information 423 is not to be used (S17: NO), the controller 61 executes step S15 described above. In this case, the toner amount switching information 422 includes information indicating that the first toner amount information 421A is to be referenced.

On the other hand, when the toner amount adjustment information 423 is to be used (S17: YES), the controller 61 determines the post-recycling toner amount of the toner cartridge 4 using the toner amount adjustment information 423 (S18). In this case, the toner amount switching information 422 includes information indicating that the toner amount adjustment information 423 is to be referenced.

In step S18, the controller 61 references the toner amount adjustment information 423 to determine the post-recycling toner amount of the toner cartridge 4. In a case where the toner amount adjustment information 423 is an adjustment value indicating the post-recycling toner amount of the toner cartridge 4, in step S18 the controller 61 determines the post-recycling toner amount of the toner cartridge 4 using the toner amount adjustment information 423. In a case where the toner amount adjustment information 423 is an adjustment value indicating the difference between the first toner amount information 421A and the post-recycling toner amount of the toner cartridge 4, in step S18 the controller 61 determines the post-recycling toner amount of the toner cartridge 4 using both the first toner amount information 421A and the toner amount adjustment information 423.

Next, the controller 61 determines whether the post-recycling toner amount of the toner cartridge 4 determined in step S18 meets a predetermined condition (S19). In other words, in step S19, the controller 61 determines whether an item that is related to the operational settings and is determined using the toner amount adjustment information 423, satisfies a predetermined condition. Specifically, in step S19 the controller 61 determines whether the post-recycling toner amount determined in S18 meets the condition where the post-recycling toner amount determined in S18 is less than or equal to the second toner amount information 421B.

When the determined post-recycling toner amount does not satisfy the predetermined condition (S19: NO), the controller 61 executes step S13 described above. In other words, the controller 61 executes step S13 when the determined post-recycling toner amount does not meet the condition where the determined post-recycling toner amount is less than or equal to the second toner amount information 421B. When the determined post-recycling toner amount meets the predetermined condition (S19: YES), the controller 61 configures the operational settings using the toner amount adjustment information 423 (S20). Note that steps S14 through S18, and step S20 are an example of the configuration process.

Retuning to FIG. 5, after the first operational setting process, the controller 61 executes the second operational setting process. The second operational setting process will be described with reference to FIG. 7. The second operational setting process is an operational setting process performed based on information that is stored in the toner memory 42 and that is related to the control of the fixing unit 34 of the image-forming unit 30. Note that the operational settings related to each of the fixing control information 425A-425D included in the toner cartridge information 420 are configured according to the same controlling steps in the present embodiment. Therefore, in the following description, the operational settings related to the first fixing control information 425A will be described.

As illustrated in FIG. 7, the controller 61 reads the area ES, which is subject to a digital signature (S30). In other words, in step S30, the controller 61 reads the first fixing control information 425A stored in the area ES, which is subject to a digital signature. After step S30, the controller 61 executes step 31. Note that steps S31-S33 of the second operational setting process are similar to steps S11-S13 of the first operational setting process, and thus, descriptions of these steps will be omitted.

When the controller 61 determines that information tampering has not occurred in step S32 (S32: NO), the controller 61 determines whether the first fixing control switching information 426A is stored in the toner memory 42 (S34). When the first fixing control switching information 426A is not stored (S34: NO), the controller 61 configures the operational settings using the first fixing control information 425A (S35). After step S35, the controller 61 ends the second operational setting process. However, when the first fixing control switching information 426A is stored (S34: YES), the controller 61 reads the first fixing control switching information 426A (S36).

Next, the controller 61 determines whether the first fixing control switching information 426A read in step S36 includes information indicating that the first fixing control adjustment information 427A is to be used (S37). When the first fixing control adjustment information 427A is not to be used (S37: NO), the controller 61 executes step S35 described above. In this case, the first fixing control switching information 426A includes information indicating that the first fixing control information 425A is to be referenced.

On the other hand, when the first fixing control adjustment information 427A is to be used (S37: YES), the controller 61 configures the operational settings using the first fixing control adjustment information 427A (S38). In this case, the first fixing control switching information 426A includes information indicating that the first fixing control adjustment information 427A is to be referenced. Note that steps S34 through S38 are an example of the configuration process. After step S38, the controller 61 ends the second operational setting process.

### Second Embodiment

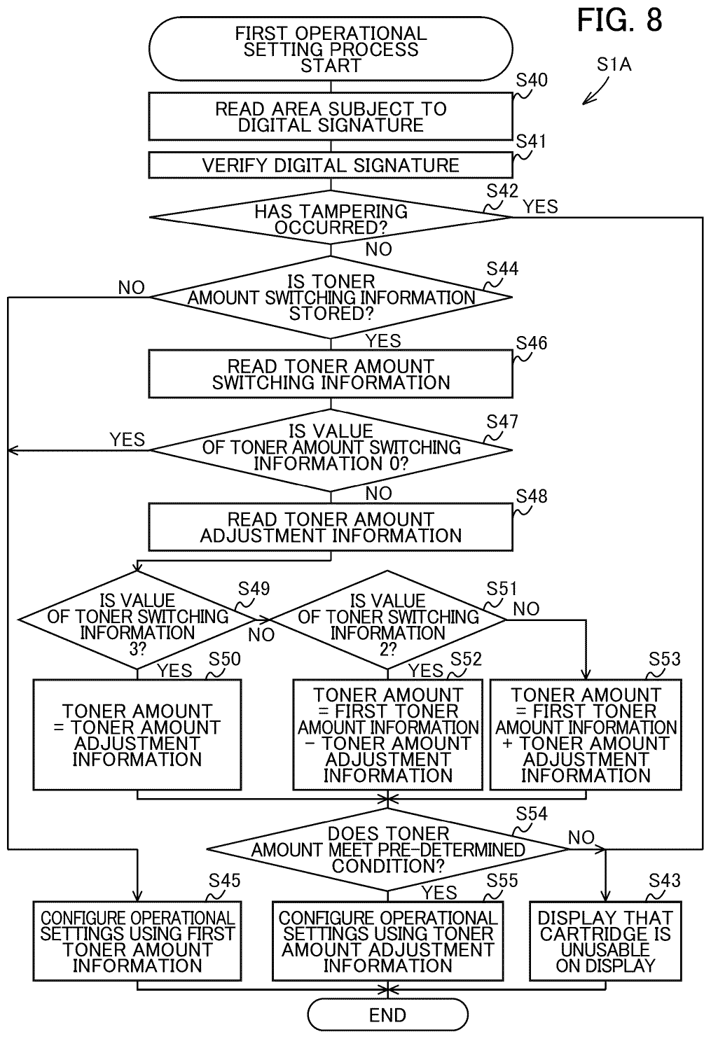

Below, another embodiment of the present disclosure will be described with reference to FIG. 8. FIG. 8 is a flowchart illustrating an example of steps in a first operational setting process according to a second embodiment. Note that, for convenience, like parts and components having the same functions as the parts and components in the first embodiment are designated with the same reference numerals to avoid duplicate descriptions.

The first operational setting process according to the second embodiment differs from the first operational setting process according to the first embodiment in that the toner amount switching information 422 is set to a value corresponding to the type of the toner amount adjustment information 423 for determining the post-recycling toner amount. Note that steps S40-S46, and S54-S55 illustrated in FIG. 8 are similar respectively to steps S10-S16, and S19-S20 illustrated in FIG. 6, and thus, descriptions of these steps will be omitted.

As illustrated in FIG. 8, after step S46, the controller 61 determines whether the value of the toner amount switching information 422 is “0” (S47). When the value of the toner amount switching information 422 is “0” (S47: YES), the controller 61 executes step S45. In other words, in a case where the operational settings are to be configured using the first toner amount information 421A, the value of the toner amount switching information 422 is set to “0”. In this case, the value “0” of the toner amount switching information 422 is information indicating that the first toner amount information 421A is to be referenced. On the other hand, when the value of the toner amount switching information 422 is not “0” (S47: NO), the controller 61 reads the toner amount adjustment information 423 (S48).

After step S48, the controller determines whether the value of the toner amount switching information 422 is “3” (S49). When the value of the toner amount switching information 422 is “3” (S49: YES), the controller 61 determines that the post-recycling toner amount is equivalent to the toner amount adjustment information 423 (S50). For example, in a case where the toner amount adjustment information 423 is an adjustment value indicating the post-recycling toner amount of the toner cartridge 4, the value of the toner amount switching information 422 is set to “3”. In this case, the value “3” of the toner amount switching information 422 is information indicating that the toner amount adjustment information 423 is to be referenced.

After step S50, the controller 61 executes step S54. On the other hand, when the value of the toner amount switching information 422 is not “3” (S49: NO), the controller 61 determines whether the value of the toner amount switching information 422 is “2” (S51).

When the value of the toner amount switching information 422 is “2” (S51: YES), the controller 61 determines that the post-recycling toner amount is equivalent to the value obtained by subtracting the toner amount adjustment information 423 from the first toner amount information 421A (S52). After step S52, the controller executes step S54. On the other hand, when the value of the toner amount switching information 422 is not “2” (S51: NO), the controller 61 determines that the post-recycling toner amount is equivalent to the value obtained by adding the toner amount adjustment information 423 to the first toner amount information 421A (S53). For example, in a case where the toner amount adjustment information 423 is an adjustment value indicating the difference between the post-recycling toner amount and the first toner amount information 421A in steps S51 through S53, the value of the toner amount switching information 422 is set to “2” when the difference is expressed as a positive value, whereas the value of the toner amount switching information 422 is set to “1” when the difference is expressed as a negative value. In other words, in a case where the toner amount switching information 422 is the difference from the first toner amount information 421A, the toner amount switching information 422 is set to a value based on the difference (and specifically, based on how the difference is expressed). After step S53, the controller 61 executes step S54.

Each of the values “2” and “1” of the toner amount switching information 422 in steps S51 through S53 is information indicating that the first toner amount information 421A and the toner amount adjustment information 423 are to be referenced.

### Effects and Advantages of Present Embodiments

According to the present embodiments as described above, since the toner amount information 421 and the fixing control information 425, which are the main information, are stored in the area ES, which is subject to a digital signature, information tampering can be detected based on the digital signature. Furthermore, the toner amount switching information 422 and the fixing control switching information 426 can be stored in the area not subject to a digital signature in the toner memory 42. Therefore, for example, in the first operational setting process, when the toner amount switching information 422 is stored in the area not subject to a digital signature in the toner memory 42, the operational settings can be configured using the reference information based on the toner amount switching information 422. The second operational setting process is similar to the first operational setting process in this respect. Accordingly, the operational settings based on the toner cartridge 4 can be easily configured while restricting tampering of the toner amount information 421 and the fixing control information 425.

Furthermore, for example, in the first operational setting process, the controller 61 can configure the operational settings based on the toner cartridge 4 using the toner amount adjustment information 423. The second operational setting process is similar to the first operational setting process in this respect. As a result, the likelihood of malfunctions occurring in the operation of the image-forming device 1 due to the attachment of the toner cartridge 4 can be reduced.

Furthermore, for example, in the first operational setting process, the controller 61 references the toner amount information 421 even when the toner amount switching information 422 is stored. The second operational setting process is similar to the first operational setting process in this respect. Therefore, information identical to the toner amount information 421 and the fixing control information 425 need not be stored in the area not subject to a digital signature in the toner memory 42. Hence, the required capacity of the toner memory 42 can be reduced.

Furthermore, for example, in the first operational setting process, when the toner amount switching information 422 is stored, the controller 61 configures the operational settings using both the toner amount information 421 and the toner amount adjustment information 423. The second operational setting process is similar to the first operational setting process in this respect. Therefore, the toner amount adjustment information 423 and the fixing control adjustment information 427 can be set to values corresponding to the toner amount information 421 and the fixing control information 425, respectively. As a result, the amount of information in the toner amount adjustment information 423 and the fixing control adjustment information 427 can be reduced.

Furthermore, for example, in the first operational setting process, when the toner amount switching information 422 is stored, the controller 61 configures the operational settings using the toner amount adjustment information 423. The second operational setting process is similar to the first operational setting process in this respect. Therefore, the operational settings can be configured without referencing either the toner amount information 421 or the fixing control information 425. Accordingly, the operational settings based on the toner cartridge 4 can be configured.

Furthermore, by executing the determining process, the controller 61 can determine whether the toner cartridge 4 attached to the main body housing 10 is usable. Therefore, whether the attached toner cartridge 4 is usable can be recognized. As a result, the likelihood of malfunctions occurring in the operation of the image-forming device 1 can be reduced.

Furthermore, by executing the displaying process, the controller 61 displays on the display that the toner cartridge 4 is unusable when the item related to the operational settings is determined not to satisfy the predetermined condition in the determining process. Therefore, the user can recognize that an unusable consumable has been attached to the device body. Accordingly, the likelihood of malfunctions occurring in the operation of the image-forming device 1 due to the attachment of unusable consumables can be further reduced.

Furthermore, since the operational settings are the settings related to the operation of the image-forming unit 30, the settings for the operation of the image-forming unit 30 are determined based on the toner cartridge 4. Therefore, the image-forming unit 30 can be made to operate based on the toner cartridge 4. As a result, the likelihood of malfunctions occurring due to the operation of the image-forming unit 30 can be reduced.

Furthermore, according to the control method of controlling the image-forming device 1, the same advantages as those obtained from the image-forming device 1 can be obtained.

Furthermore, according to the toner cartridge 4 to be attached to the main body housing 10, the same advantages as those obtained from the image-forming device 1 can be obtained.

### Implementation through Software

The functions of the image-forming device 1 may be implemented by a program that enables a computer to function as the image-forming device 1, and specifically by a program that enables a computer to function as the controller 61 of the image-forming device 1.

In this case, the image-forming device 1 includes, as hardware for executing the program described above, a computer having at least one control device (e.g., a processor) and at least one storage device (e.g., a memory). The functions in each of the embodiments described above are implemented by executing the above-described program using the control device and the storage device described above.

The program may be stored in one or more non-transitory computer-readable storage media. The one or more storage media described above may be provided in the image-forming device 1 but need not be provided in the image-forming device 1. In the latter case, the program may be transmitted to the image-forming device 1 through any wired or wireless transmission medium.

Some or all of the functions of the controller 61 may also be implemented by one or more logic circuits. For example, an integrated circuit having logic circuits that function as the controller 61 is also within the scope of the present disclosure.

Additionally, some or all of the functions of the controller 61 may also be implemented by one or more microprocessors with one or more built-in IC chips.

### Supplementary Information

For example, when the remaining toner stored in the toner cartridge 4 is depleted, the toner cartridge 4 attached to the image-forming device 1 is collected by a service provider to be refilled with toner, and is delivered to the user again. In other words, recycling is performed. However, the toner cartridge 4 after recycling is not necessarily refilled with the same amount of toner as the amount of toner before recycling. For example, the amount of toner after recycling may be less than or more than the amount of toner before recycling. Thus, in a case where the amount of toner differs between before and after recycling, the operational settings based on the toner cartridge 4 after recycling may be suitable.

Furthermore, in order to configure the operational settings based on the amount of toner stored in the toner cartridge 4 after recycling, it is conceivable to change the toner amount information 421, which is the basic information for the operational settings. However, since the toner amount information 421 is stored in the area ES subject to a digital signature in order to detect information tampering, the rewriting of the toner amount information 421 necessitates reapplying a digital signature.

As described above, according to the present disclosure, the toner amount switching information 422 and the toner amount adjustment information 423 are stored in the area other than the area ES subject to a digital signature in the toner memory 42. Therefore, the toner amount switching information 422 and the toner amount adjustment information 423 can be written in the toner memory 42 of the toner cartridge 4 after recycling. Accordingly, the configuration process according to the present disclosure can be executed without rewriting the toner amount information 421. As a result, suitable control based on the amount of toner stored in the toner cartridge 4 after recycling can be achieved.

Note that the switching information and the adjustment information according to the present disclosure are not limited to a configuration in which the switching information and the adjustment information are written in the consumable memory of the consumable after recycling. In other words, at least one of the switching information or the adjustment information may be written in the consumable memory of the consumable before recycling.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

The present disclosure encompasses the following aspects.

According to Aspect 1, the present disclosure provides an image-forming device including a device main body, a consumable, and a controller. The consumable is attachable to the device main body. The consumable includes a consumable memory has a first area subject to a digital signature, and a second area not subject to a digital signature. The controller is configured to perform a configuration process. The configuration process includes configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The configuration process further includes configuring, when the switching information is stored in the second area of the consumable memory, the operational setting using the reference information based on the switching information.

With the above configuration according to Aspect 1, since the basic information, which is the main information, is stored in the area subject to a digital signature (i.e., the first area), information tampering can be detected based on the digital signature. Furthermore, the switching information can be stored in the area not subject to a digital signature (i.e., the second area) in the consumable memory. Therefore, in the configuration process, when the switching information is stored in the area not subject to a digital signature (i.e., the second area) in the consumable memory, the operational setting of the image-forming device can be configured using the reference information based on the switching information. Accordingly, the operational setting based on the consumable can be easily configured while restricting tampering of the basic information.

According to Aspect 2 of the present disclosure, in the configuration process in the image-forming device according to Aspect 1, the controller uses, as the reference information based on the switching information, the basic information stored in the first area of the consumable memory.

With the above configuration according to Aspect 2, even when the switching information is stored, the operational setting of the image-forming device is configured using the basic information. Therefore, information identical to the basic information need not be stored in the area not subject to a digital signature (i.e., the second area) in the consumable memory. Accordingly, the required capacity of the consumable memory can be reduced.

According to Aspect 3 of the present disclosure, in the configuration process in the image-forming device according to Aspect 1, the controller uses, as the reference information based on the switching information, both the basic information stored in the first area of the consumable memory and adjustment information stored in the second area of the consumable memory, the adjustment information indicating an adjustment value for configuring the operational setting based on the consumable.

With the above configuration according to Aspect 3, when the switching information is stored, the operational setting of the image-forming device is configured using the basic information and the adjustment information. Therefore, the adjustment information can be set to a value corresponding to the basic information. Hence, the amount of information in the adjustment information can be reduced. Moreover, by referencing the adjustment information, the operational setting based on the consumable can be configured. As a result, the likelihood of malfunctions occurring in the operation of the image-forming device due to the attachment of the consumable can be reduced.

According to Aspect 4 of the present disclosure, in the configuration process in the image-forming device according to Aspect 1, the controller uses, as the reference information based on the switching information, at least adjustment information stored in the second area of the consumable memory, the adjustment information indicating an adjustment value for configuring the operational setting based on the consumable.

With the above configuration according to Aspect 4, when the switching information is stored, the operational setting of the image-forming device is configured using the adjustment information. Therefore, the operational setting of the image-forming device can be configured without referencing the basic information. As a result, the operational setting of the image-forming device based on the consumable can be configured. Moreover, by referencing the adjustment information, the operational setting based on the consumable can be configured. As a result, the likelihood of malfunctions occurring in the operation of the image-forming device due to the attachment of the consumable can be reduced.

According to Aspect 5 of the present disclosure, the controller of the image-forming device according to Aspect 1 is configured to further perform a determining process. The determining process determines whether an item meets a predetermined condition. The item is determined by the configuration process and is related to the operational setting.

With the above configuration according to Aspect 5, by performing the determining process, whether the consumable attached to the device main body is usable can be determined. Therefore, whether the attached consumable is usable can be recognized. Therefore, the likelihood of malfunctions occurring in the operation of the image-forming device can be reduced.

According to Aspect 6 of the present disclosure, the image-forming device according to Aspect 5 further includes a display. The controller is configured to further perform a displaying process when the item does not meet the predetermined condition in the determining process. The displaying process includes displaying on the display that the consumable is unusable.

With the above configuration according to Aspect 6, by performing the displaying process, when the item related to the operational setting is determined not to meet the predetermined condition in the determining process, the display displays that the consumable is unusable. Therefore, the user can recognize that an unusable consumable has been attached to the device main body. Thus, the likelihood of malfunctions occurring in the operation of the image-forming device due to the attachment of unusable consumables can be further reduced.

According to Aspect 7 of the present disclosure, the image-forming device according to Aspect 1 further includes an image-forming unit. The image-forming unit includes a photosensitive drum, a developing roller, a transfer belt, and a fixing device. The developing roller is configured to supply toner onto the photosensitive drum. The transfer belt is configured to transfer the toner supplied on the photosensitive drum onto a printing medium. The fixing device includes a heating roller. The fixing device is configured to fix the toner transferred on the printing medium onto the printing medium by heating the printing medium using the heating roller. The operational setting is related to a setting for an operation of the image-forming unit.

With the above configuration according to Aspect 7, since the operational setting is the setting related to the operation of the image-forming unit, the setting for the operation of the image-forming unit is determined based on the consumable. Therefore, the image-forming unit can be made to operate based on the consumable. As a result, the likelihood of malfunctions occurring due to the operation of the image-forming unit can be reduced.

According to Aspect 8, the present disclosure provides a control method of controlling an image-forming device. The image-forming device includes a device main body, a controller, and a consumable. The consumable is attachable to the device main body. The consumable includes a consumable memory. The consumable memory has a first area subject to a digital signature, and a second area not subject to a digital signature. The control method includes the controller configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The control method further includes the controller configuring, when the switching information is stored in the second area of the consumable memory, the operational setting using the reference information based on the switching information.

With the above configuration according to Aspect 8, the same advantages as those obtained from the image-forming device according to Aspect 1 can be obtained.

According to Aspect 9, the present disclosure provides a consumable attachable to an image-forming device including a controller. The consumable includes a consumable memory. The consumable memory has a first area subject to a digital signature, and a second area not subject to a digital signature. The controller is configured to perform a configuration process. The configuration process includes configuring, when switching information is not stored in the second area of the consumable memory, an operational setting of the image-forming device using basic information stored in the first area of the consumable memory. The switching information is for switching reference information to be used for configuring the operational setting. The basic information is information related to the operational setting. The configuration process further includes configuring, when the switching information is stored in the second area of the consumable memory, the operational setting using the reference information based on the switching information.

With the above configuration according to Aspect 9, the same advantages as those obtained from the image-forming device according to Aspect 1 can be obtained.

What is claimed is:

1. An image-forming device comprising:
a device main body;
a consumable attachable to the device main body, the consumable including a consumable memory having:
a first area subject to a digital signature; and
a second area not subject to a digital signature; and
a controller configured to perform a configuration process including:
configuring, when switching information is not stored in the second area of the consumable memory, an operational setting of the image-forming device using basic information stored in the first area of the consumable memory, the switching information being for switching reference information to be used for configuring the operational setting, the basic information being information related to the operational setting; and
configuring, when the switching information is stored in the second area of the consumable memory, the operational setting using the reference information based on the switching information.

2. The image-forming device according to claim 1,
wherein, in the configuration process the controller uses, as the reference information based on the switching information, the basic information stored in the first area of the consumable memory.

3. The image-forming device according to claim 1,
wherein, in the configuration process the controller uses, as the reference information based on the switching information, both the basic information stored in the first area of the consumable memory and adjustment information stored in the second area of the consumable memory, the adjustment information indicating an adjustment value for configuring the operational setting based on the consumable.

4. The image-forming device according to claim 1,
wherein, in the configuration process, the controller uses, as the reference information based on the switching information, adjustment information stored in the second area of the consumable memory, the adjustment information indicating an adjustment value for configuring the operational setting based on the consumable.

5. The image-forming device according to claim 1,
wherein the controller is configured to further perform a determining process including:
determining whether an item meets a predetermined condition, the item being determined by the configuration process and being related to the operational setting.

6. The image-forming device according to claim 5, further comprising:
a display,
wherein the controller is configured to further perform a displaying process when determining that the item does not meet the predetermined condition in the determining process, the displaying process including:
displaying on the display that the consumable is unusable.

7. The image-forming device according to claim 1, further comprising:
an image-forming unit including:
a photosensitive drum;
a developing roller configured to supply toner onto the photosensitive drum;
a transfer belt configured to transfer the toner supplied on the photosensitive drum onto a printing medium; and
a fixing device including a heating roller, the fixing device being configured to fix the toner transferred on the printing medium onto the printing medium by heating the printing medium using the heating roller,
wherein the operational setting is related to a setting for an operation of the image-forming unit.

8. A control method of controlling an image-forming device, the image-forming device including: a device main body; a controller; and a consumable attachable to the device main body, the consumable including a consumable memory, the consumable memory having a first area subject to a digital signature and a second area not subject to a digital signature,
the control method comprising:
the controller configuring, when switching information is not stored in the second area of the consumable memory, an operational setting of the image-forming device using basic information stored in the first area of the consumable memory, the switching information being for switching reference information to be used for configuring the operational setting, the basic information being information related to the operational setting; and
the controller configuring, when the switching information is stored in the second area of the consumable memory, the operational setting using the reference information based on the switching information.

9. A consumable attachable to an image-forming device including a controller, the consumable comprising:
a consumable memory having:
a first area subject to a digital signature; and
a second area not subject to a digital signature,
wherein the controller is configured to perform a configuration process including:
configuring, when switching information is not stored in the second area of the consumable memory, an operational setting of the image-forming device using basic information stored in the first area of the consumable memory, the switching information being for switching reference information to be used for configuring the operational setting, the basic information being information related to the operational setting; and
configuring, when the switching information is stored in the second area of the consumable memory, the operational setting using the reference information based on the switching information.
